(19) United States
(12) Patent Application Publication
(10) Pub. No.: US 2026/0089704 A1
(43) Pub. Date: Mar. 26, 2026

(54) METHOD AND APPARATUS FOR UPLINK SYNCHRONIZATION ACCORDING TO BEAM SWITCHING IN COMMUNICATION NETWORK

(71) Applicant: ELECTRONICS AND TELECOMMUNICATIONS RESEARCH INSTITUTE, Daejeon (KR)

(72) Inventors: Namsuk LEE, Daejeon (KR); Hee Sang CHUNG, Daejeon (KR)

(73) Assignee: ELECTRONICS AND TELECOMMUNICATIONS RESEARCH INSTITUTE, Daejeon (KR)

(21) Appl. No.: 19/337,638

(22) Filed: Sep. 23, 2025

(30) Foreign Application Priority Data
Sep. 26, 2024 (KR) 10-2024-0131140
Sep. 16, 2025 (KR) 10-2025-0133074

(51) Int. Cl. H04W 72/044; H04W 8/22; H04W 74/0833

(52) U.S. Cl. CPC H04W 72/046; H04W 8/22; H04W 74/0833

(57) ABSTRACT

A method of a terminal may comprise: receiving, through a serving beam, a PDCCH order including information on a target beam from a base station; transmitting, based on the PDCCH order, a RACH preamble to the base station through the target beam; receiving, through the serving beam, TA information for the target beam from the base station, the TA information being determined based on the RACH preamble; receiving, through the serving beam, beam switching indication information from the base station; performing a beam switching operation from the serving beam to the target beam based on the beam switching indication information, using the TA information; and acquiring uplink synchronization for the target beam based on the TA information.

### CROSS-REFERENCE TO RELATED APPLICATIONS

This application claims priority to Korean Patent Applications No. 10-2024-0131140, filed on Sep. 26, 2024, and No. 10-2025-0133074, filed on Sep. 16, 2025, with the Korean Intellectual Property Office (KIPO), the entire contents of which are hereby incorporated by reference.

### BACKGROUND

### 1. Technical Field

The present disclosure relates to an uplink synchronization technique, and more particularly, to an uplink synchronization method and apparatus for uplink synchronization acquisition between a base station and a terminal in a beam switching procedure of a communication network including a reconfigurable intelligent surface (RIS).

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

To process rapidly increasing wireless data, 5G NR communication or subsequent wireless communication technologies may support communication in a relatively high-frequency band. The high-frequency band may refer to a relatively high-frequency band exceeding approximately 7 GHz and may include, for example, a 28-29 GHz band, an unlicensed band, a millimeter-wave band, or a terahertz-wave band.

In a communication network using such high-frequency bands, path loss of a signal and the like may occur at a high level. A base station may use a beamforming technology capable of concentrating transmission power in a specific beam direction, for example, in a terminal direction, in order to compensate for path loss in the high-frequency bands.

A beam transmitted by the base station in the communication network may be blocked by an obstacle such as a building existing in a cell area and may not be delivered to a terminal. In the cell area, a plurality of shadow areas in which communication between the base station and the terminal is disconnected due to obstacles may occur. To solve this, the communication network may include at least one reconfigurable intelligent surface (RIS) capable of delivering beams to the plurality of shadow areas. The RIS may reflect a beam received from the base station in a desired direction, for example, in a terminal direction of a shadow area.

A terminal may move into a shadow area while receiving a transmission beam of the base station. In this case, the terminal may receive a beam reflected via the RIS from the base station, thereby maintaining continuity of a communication service between the terminal and the base station. Here, the transmission beam of the base station and the reflection beam of the RIS may have different propagation delay times. Accordingly, when a beam switching from the transmission beam of the base station to the reflection beam of the RIS occurs, uplink synchronization between the terminal and the base station may be misaligned, which may cause a problem in which continuity of the communication service cannot be guaranteed. Therefore, in the communication network including the RIS, a solution capable of maintaining continuity of the communication service between the base station and the terminal is required.

### SUMMARY

The present disclosure for resolving the above-described problems is directed to providing an uplink synchronization method and apparatus for uplink synchronization acquisition between a base station and a terminal in a beam switching procedure of a communication network.

According to a first exemplary embodiment of the present disclosure, a method of a terminal may comprise: receiving, through a serving beam, a physical downlink control channel (PDCCH) order including information on a target beam from a base station; transmitting, based on the PDCCH order, a random access channel (RACH) preamble to the base station through the target beam; receiving, through the serving beam, timing advance (TA) information for the target beam from the base station, the TA information being determined based on the RACH preamble; receiving, through the serving beam, beam switching indication information from the base station; performing a beam switching operation from the serving beam to the target beam based on the beam switching indication information, using the TA information; and acquiring uplink synchronization for the target beam based on the TA information.

The serving beam may be a beam directly received from the base station, and the target beam may be a beam received via at least one reconfigurable intelligent surface (RIS) associated with the base station.

The performing of the beam switching operation may comprise: determining whether the TA information corresponds to a switching beam included in the beam switching indication information; and performing the beam switching operation from the serving beam to the target beam based on determining that the TA information corresponds to the switching beam.

The performing of the uplink synchronization may comprise: adjusting an uplink transmission timing for the target beam based on a TA value of the target beam included in the TA information.

The method may further comprise: receiving a plurality of channel state information (CSI)-reference signals (RSs) from the base station; measuring signal quality of each of the plurality of CSI-RSs; and transmitting signal quality measurement results to the base station, wherein the information on the target beam, which is included in the PDCCH order, is determined based on the signal quality measurement results.

The method may further comprise: receiving a plurality of CSI-RSs from the base station; measuring signal quality of each of the plurality of CSI-RSs; and transmitting signal quality measurement results to the base station, wherein the beam switching indication information is received from the base station based on the signal quality measurement results.

According to a second exemplary embodiment of the present disclosure, a method of a base station may comprise: transmitting, through a serving beam, a physical downlink control channel (PDCCH) order including information on a target beam for a beam switching operation of a terminal to the terminal; receiving, through the target beam, a random access channel (RACH) preamble based on the PDCCH order from the terminal; measuring a timing advance (TA) value for the target beam based on the RACH preamble; transmitting TA information including the TA value to the terminal through the serving beam; and transmitting, through the serving beam, beam switching indication information for switching from the serving beam to the target beam to the terminal, based on determination of whether the beam switching operation of the terminal is to be performed.

The transmitting of the PDCCH order to the terminal through the serving beam may comprise: transmitting a plurality of channel state information (CSI)-reference signals (RSs) to the terminal; receiving, from the terminal, signal quality measurement results for the plurality of CSI-RSs; determining the serving beam and the target beam among the plurality of CSI-RSs based on the signal quality measurement results; and transmitting, through the serving beam, the PDCCH order including information on the target beam to the terminal.

The PDCCH order may include at least one of: information on a dedicated preamble, or a CSI-RS index or a transmission configuration indicator (TCI) state identifier (ID) of the target beam.

The TA information may include at least one of: the TA value of the target beam, an SSB beam index for the target beam, or a CSI-RS index or a TCI state ID of the target beam.

The transmitting of the beam switching indication information may comprise: transmitting a plurality of CSI-RSs to the terminal; receiving, from the terminal, signal quality measurement results for the plurality of CSI-RSs; determining that the terminal is to perform the beam switching operation when a signal quality of the target beam is relatively better than a signal quality of the serving beam; and transmitting, through the serving beam, the beam switching indication information to the terminal.

The serving beam may be a beam directly transmitted from the base station to the terminal, and the target beam may be a beam transmitted to the terminal via at least one reconfigurable intelligent surface (RIS) associated with the base station.

According to a third exemplary embodiment of the present disclosure, a terminal may comprise at least one processor, and the at least one processor may cause the terminal to perform: receiving, through a serving beam, a physical downlink control channel (PDCCH) order including information on a target beam from a base station; transmitting, based on the PDCCH order, a random access channel (RACH) preamble to the base station through the target beam; receiving, through the serving beam, timing advance (TA) information for the target beam from the base station, the TA information being determined based on the RACH preamble; receiving, through the serving beam, beam switching indication information from the base station; performing a beam switching operation from the serving beam to the target beam based on the beam switching indication information, using the TA information; and acquiring uplink synchronization for the target beam based on the TA information.

The serving beam may be a beam directly received from the base station, and the target beam may be a beam received via at least one reconfigurable intelligent surface (RIS) associated with the base station.

In the performing of the beam switching operation, the at least one processor may cause the terminal to perform: determining whether the TA information corresponds to a switching beam included in the beam switching indication information; and performing the beam switching operation from the serving beam to the target beam based on determining that the TA information corresponds to the switching beam.

In the performing of the uplink synchronization, the at least one processor may further cause the terminal to perform: adjusting an uplink transmission timing for the target beam based on a TA value of the target beam included in the TA information.

The at least one processor may further cause the terminal to perform: receiving a plurality of channel state information (CSI)-reference signals (RSs) from the base station; measuring signal quality of each of the plurality of CSI-RSs; and transmitting signal quality measurement results to the base station, wherein the information on the target beam, which is included in the PDCCH order, is determined based on the signal quality measurement results.

The at least one processor may further cause the terminal to perform: receiving a plurality of CSI-RSs from the base station; measuring signal quality of each of the plurality of CSI-RSs; and transmitting signal quality measurement results to the base station, wherein the beam switching indication information is received from the base station based on the signal quality measurement results.

According to the present disclosure, a terminal can perform a beam switching operation from a serving beam of a base station to a target beam of an RIS based on target beam information received from the base station, and can acquire uplink synchronization for the switched target beam based on the target beam information. Accordingly, the terminal can prevent uplink synchronization from being misaligned due to a difference in propagation delay time between the serving beam and the target beam transmitted from the base station, and can guarantee continuity of a communication service between the base station and the terminal.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram illustrating an exemplary embodiment of a beamforming method of a base station in a communication network.

FIG. 4 is a sequence chart illustrating an exemplary embodiment of an initial access procedure of a terminal in a communication network.

FIG. 5 is a conceptual diagram illustrating an exemplary embodiment of a beamforming method of a base station in a communication network including a reconfigurable intelligent surface (RIS).

FIG. 6 is a conceptual diagram illustrating an exemplary embodiment of a beamforming method of a base station according to terminal movement in a communication network including an RIS.

FIG. 7 is a sequence chart illustrating an exemplary embodiment of an uplink synchronization method according to beam switching operation of a terminal in a communication network.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In exemplary embodiments of the present disclosure, “(re) transmission” may mean “transmission”, “retransmission”, or “transmission and retransmission”, “(re) configuration” may mean “configuration”, “reconfiguration”, or “configuration and reconfiguration”, “(re) connection” may mean “connection”, “reconnection”, or “connection and reconnection”, and “(re) access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e. “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication network to which exemplary embodiments according to the present disclosure are applied will be described. The communication network may be a non-terrestrial network (NTN), a 4G communication network (e.g. Long-Term Evolution (LTE) communication network), a 5G communication network (e.g. New Radio (NR) communication network), or a B5G mobile communication network (e.g. 6G mobile communication network). The 4G communication network and the 5G communication network may be classified as terrestrial networks.

In exemplary embodiments, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. The signaling may be at least one of system information (SI) signaling (e.g. transmission of system information block (SIB) and/or master information block (MIB)), RRC signaling (e.g. transmission of RRC parameters and/or higher layer parameters), MAC control element (CE) signaling, or PHY signaling (e.g. transmission of downlink control information (DCI), uplink control information (UCI), and/or sidelink control information (SCI)).

In the present disclosure, even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

In the present disclosure, a phrase including “when ˜” may be expressed as a phrase including “based on ˜” or as a phrase including “in response to ˜”. In other words, a phrase including “when ˜” may be interpreted as being the same as or similar to a phrase including “based on ˜” or a phrase including “in response to ˜”.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

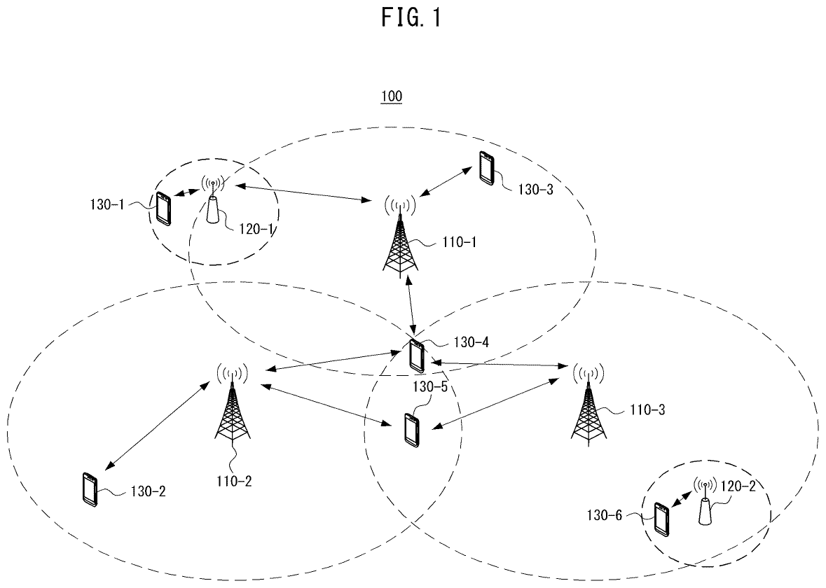

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes 110-1, 110-2, 110-3, 120-1, 120-2, 130-1, 130-2, 130-3, 130-4, 130-5, and 130-6 may include a plurality of base stations 110-1, 110-2, 110-3, 120-1, and 120-2) and a plurality of terminals, for example, a plurality of user terminals 130-1, 130-2, 130-3, 130-4, 130-5, and 130-6.

Each of the plurality of communication nodes 110-1, 110-2, 110-3, 120-1, 120-2, 130-1, 130-2, 130-3, 130-4, 130-5, and 130-6 may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHZ, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network (not shown). When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

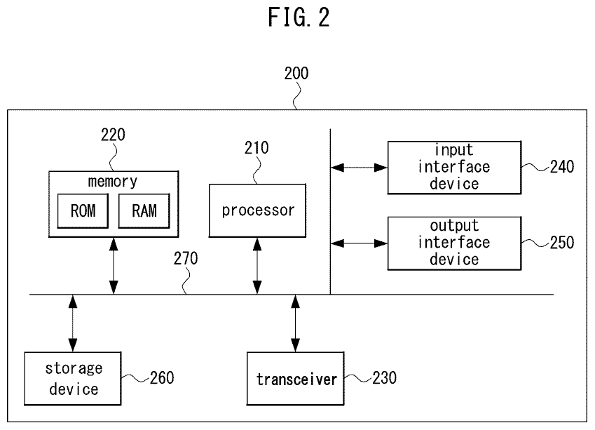

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed.

Each of the memory 220 and the storage device 260 may be constituted by at least one of a volatile storage medium and a non-volatile storage medium. For example, the memory 220 may comprise at least one of read-only memory (ROM) and random access memory (RAM).

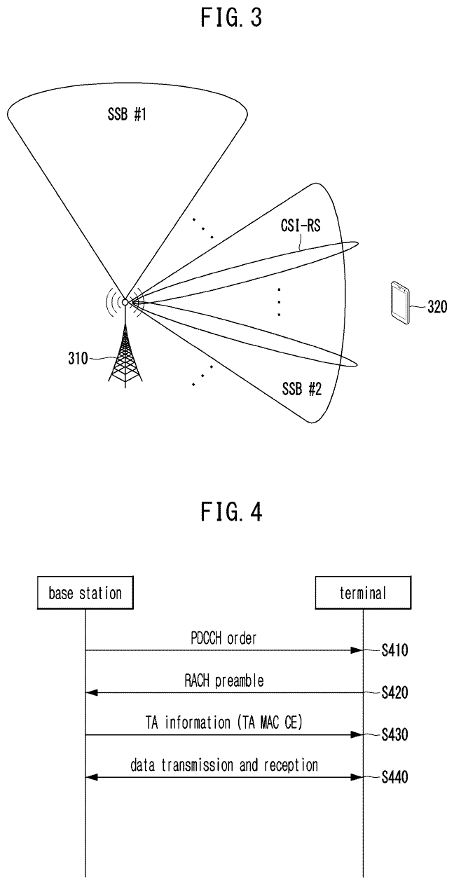

FIG. 3 is a conceptual diagram illustrating an exemplary embodiment of a beamforming method of a base station in a communication network.

Referring to FIG. 3, when a high frequency band is used in a communication network, a base station 310 may use a beamforming technique to compensate for path loss of signals. The beamforming technique may be a beam transmission and management technique that concentrates transmission power in a specific direction by using an array antenna or a parabolic antenna to transmit a beam toward a desired direction. The beamforming of the base station 310 may include synchronization signal block (SSB)-based beamforming or channel state information-reference signal (CSI-RS)-based beamforming.

The base station 310 may transmit a plurality of SSB beams SSB #1 and SSB #2 having a wide beam width in cell areas of the base station 310 through SSB-based beamforming. The base station 310 may transmit the plurality of SSB beams SSB #1 and SSB #2 to the respective cell areas in different time regions. The base station 310 may transmit the plurality of SSB beams SSB #1 and SSB #2 based on a preconfigured transmission period. For example, the base station 310 may transmit the first SSB beam SSB #1 to a first area of the cell in a first time region, and may transmit the second SSB beam SSB #2 to a second area of the cell in a second time region different from the first time region. The base station 310 may perform beam sweeping to transmit the plurality of SSB beams SSB #1 and SSB #2.

Each of the plurality of SSB beams SSB #1 and SSB #2 transmitted by the base station 310 may include at least one of a synchronization signal or system information. A terminal 320 may select one (e.g. the second SSB beam SSB #2) of the plurality of SSB beams SSB #1 and SSB #2 to acquire downlink synchronization, and may perform an initial access procedure with the base station 310 using the selected SSB beam.

After the initial access procedure with the terminal 320 is completed, the base station 310 may transmit a plurality of CSI-RS beams having a narrow beam width through CSI-RS-based beamforming. The base station 310 may transmit the plurality of CSI-RS beams to the cell area corresponding to the SSB beam selected by the terminal 320 for initial access. The terminal 320 may measure signal quality of each of the plurality of CSI-RS beams, and may report measurement results (e.g. CSI report) to the base station 310. The base station 310 may select one of the plurality of CSI-RS beams as an optimal beam based on the CSI report received from the terminal 320, and may transmit and receive data with the terminal 320 through the selected CSI-RS beam.

FIG. 4 is a sequence chart illustrating an exemplary embodiment of an initial access procedure of a terminal in a communication network.

Referring to FIGS. 3 and 4, the base station 310 may transmit the plurality of SSB beams SSB #1 and SSB #2 to the respective cell areas in different time regions. The terminal 320 may acquire downlink synchronization by selecting one of the plurality of SSB beams SSB #1 and SSB #2 transmitted from the base station 310.

The base station 310 may transmit a physical downlink control channel (PDCCH) order to the terminal 320 through the SSB beam selected by the terminal 320 (S410). The base station 310 may transmit the PDCCH order to the terminal 320 using a radio resource control (RRC) message or a downlink control information (DCI) format. The PDCCH order may include dedicated preamble information (e.g. a random access channel (RACH) preamble index) for an initial access procedure between the base station 310 and the terminal 320.

The terminal 320 may select a RACH preamble for initial access based on the PDCCH order received from the base station 310. The terminal 320 may transmit the selected RACH preamble to the base station 310 (S420).

The base station 310 may receive the RACH preamble from the terminal 320 and may measure a timing advance (TA) value based on the RACH preamble. The base station 310 may transmit TA information (S430) to the terminal 320, for example, a random access response (RAR) including a TA MAC control element (CE), the TA information including a TA value or a TA command for the TA value.

The terminal 320 may adjust a transmission timing of uplink signals based on the TA information received from the base station 310. The terminal 320 may acquire uplink synchronization with the base station 310 based on the adjusted uplink transmission timing. The terminal 320 may transmit and receive data with the base station 310 based on the synchronized uplink or downlink.

In the communication network illustrated in FIG. 3, the base station 310 may directly transmit the plurality of SSB beams SSB #1 and SSB #2 or the plurality of CSI-RS beams to the terminal 320. In other words, in the communication network, there may not exist an element that interrupts signal transmission and reception between the base station 310 and the terminal 320, and the terminal 320 may directly receive the beams transmitted through beamforming by the base station 310. In this case, a propagation delay time of each beam received by the terminal 320 from the base station 310 may be similar. For example, each of the SSB beam and the CSI-RS beam received by the terminal 320 from the base station 310 may have a similar propagation delay time. In addition, each of the plurality of CSI-RS beams received by the terminal 320 from the base station 310 may have a similar propagation delay time. Therefore, when the terminal 320 acquires uplink synchronization with the base station 310 through the initial access procedure, the terminal 320 may determine that uplink synchronization for the plurality of CSI-RS beams transmitted from the base station 310 is also acquired together. In other words, the terminal 320 may acquire uplink synchronization for initial access based on the SSB beam received from the base station 310, and the synchronized uplink may be commonly applied to data transmission and reception operations between the terminal 320 and the base station 310.

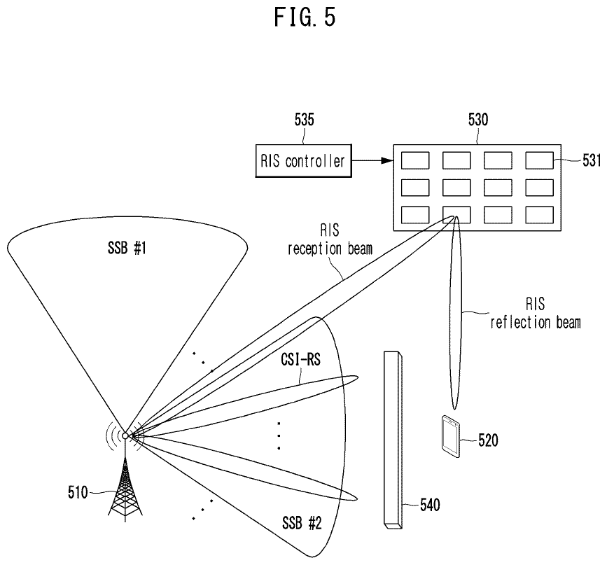

FIG. 5 is a conceptual diagram illustrating an exemplary embodiment of a beamforming method of a base station in a communication network including a reconfigurable intelligent surface (RIS).

Referring to FIG. 5, a base station 510 may transmit a plurality of SSB beams SSB #1 and SSB #2 or a plurality of CSI-RS beams to cell areas of the base station 510 through beamforming. In cell areas of the base station 510, at least one shadow area may be formed due to an obstacle 540 such as a building. The terminal 520 may be located in the shadow area, and a beam transmitted from the base station 510 may be blocked by the obstacle 540 and may not be delivered to the terminal 520. Accordingly, a communication interruption problem between the base station 510 and the terminal 520 may occur in the shadow area.

A communication network of the exemplary embodiment may include at least one reconfigurable intelligent surface (RIS) 530 to solve the communication interruption problem caused by the shadow area formed in the cell area of the base station 510. The RIS 530 may receive an SSB beam or a CSI-RS beam transmitted from the base station 510 and may reflect the beam in a predetermined direction in the cell area of the base station 510, for example, to the shadow area in which the terminal 520 is located. The beam received by the RIS 530 from the base station 510 may be referred to as ‘RIS reception beam’, and the beam reflected by the RIS 530 to the terminal 520 may be referred to as ‘RIS reflection beam’.

The RIS 530 may include a plurality of reflecting elements 531. Each of the plurality of reflecting elements 531 may be controlled by an RIS controller 535, and accordingly, the RIS controller 535 may adjust a phase or an amplitude of the RIS reflection beam and may transmit the RIS reflection beam to the terminal 520. Accordingly, when the terminal 520 is located in the shadow area of the cell area, the base station 510 may transmit a beam to the terminal 520 via the RIS 530, and communication continuity between the base station 510 and the terminal 520 may be maintained.

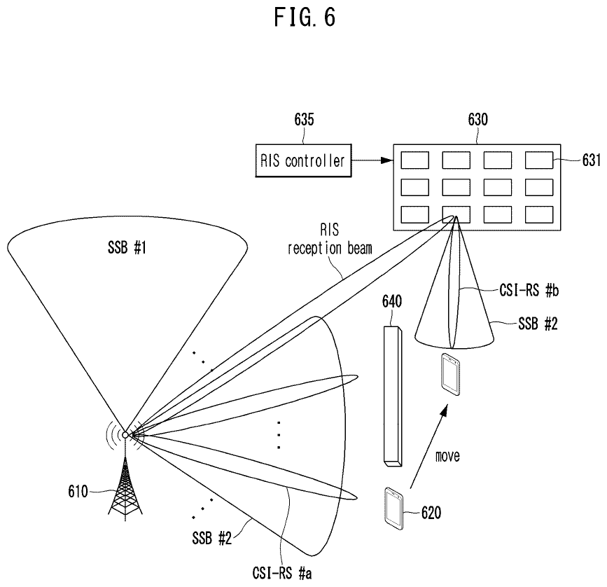

FIG. 6 is a conceptual diagram illustrating an exemplary embodiment of a beamforming method of a base station according to terminal movement in a communication network including an RIS.

Referring to FIG. 6, a communication network may include at least one RIS 630 to solve a problem caused by a shadow area formed in a cell area of a base station 610. The RIS 630 may receive a beam transmitted from the base station 610 and may reflect the beam toward a terminal 620 located in the shadow area of the cell area. The RIS 630 may include a plurality of reflecting elements 631. Each of the plurality of reflecting elements 631 may be controlled by an RIS controller 635, and the RIS controller 635 may adjust a phase or an amplitude of a beam (e.g. RIS reflection beam) transmitted from the base station 610, and may transmit the RIS reflection beam to the terminal 620.

The terminal 620 may perform an initial access procedure with the base station 610 based on an SSB beam received from the base station 610, and may acquire uplink and downlink synchronization with the base station 610. The terminal 620 may measure signal quality of the plurality of CSI-RS beams received from the base station 610, and may transmit a CSI report of measurement results to the base station 610. The base station 610 may select one of the plurality of CSI-RS beams based on the measurement report received from the terminal 620, and may transmit and receive data with the terminal 620 using the selected CSI-RS beam.

The terminal 620 may directly receive the plurality of SSB beams or the plurality of CSI-RS beams from the base station 610. In this case, each of the SSB beams and the CSI-RS beams received by the terminal 620 may have a similar propagation delay time. Therefore, the terminal 620 may commonly apply the uplink and downlink synchronization acquired through the initial access procedure to data transmission and reception operations with the base station 610.

Meanwhile, the terminal 620 may move to a shadow area of a cell area while transmitting and receiving data with the base station 610 through a CSI-RS beam. The base station 610 may perform beam switching so that a beam reflected via the RIS 630 is transmitted to the terminal 620 as the terminal 620 moves into the shadow area.

For example, the terminal 620 may select one of the plurality of SSB beams transmitted from the base station 610. The terminal 620 may perform an initial access procedure with the base station 610 through the selected SSB beam and may acquire uplink and downlink synchronization. After the initial access procedure between the base station 610 and the terminal 620 is completed, the base station 610 may select one of the plurality of CSI-RS beams (e.g. a first CSI-RS beam CSI-RS #a) based on the CSI report transmitted from the terminal 620. The base station 610 may transmit and receive data with the terminal 620 using the first CSI-RS beam CSI-RS #a.

The terminal 620 may move into a shadow area formed by an obstacle 640 in a cell area while transmitting and receiving data with the base station 610 through the first CSI-RS beam CSI-RS #a. The base station 610 may perform beam switching for the current serving beam (e.g. the first CSI-RS beam CSI-RS #a) according to movement of the terminal 620. The base station 610 may instruct the terminal 620 to perform beam switching from the first CSI-RS beam CSI-RS #a to a second CSI-RS beam CSI-RS #b reflected via the RIS 630. The second CSI-RS beam CSI-RS #b may be a beam belonging to the same SSB beam as the first CSI-RS beam CSI-RS #a.

Here, the first CSI-RS beam CSI-RS #a may be a beam directly transmitted from the base station 610 to the terminal 620, whereas the second CSI-RS beam CSI-RS #b may be a beam transmitted from the base station 610 to the terminal 620 via the RIS 630. Therefore, a difference in propagation delay time may occur between the first CSI-RS beam CSI-RS #a and the second CSI-RS beam CSI-RS #b. For example, the second CSI-RS beam CSI-RS #b may have a greater propagation delay time compared to the first CSI-RS beam CSI-RS #a. Due to this difference in propagation delay time, the uplink synchronization of the base station 610 and the terminal 620 performed in the initial access procedure may not be valid, and communication continuity between the base station 610 and the terminal 620 may not be guaranteed. Therefore, when beam switching occurs, methods capable of supporting uplink synchronization between the base station 610 and the terminal 620 may be required.

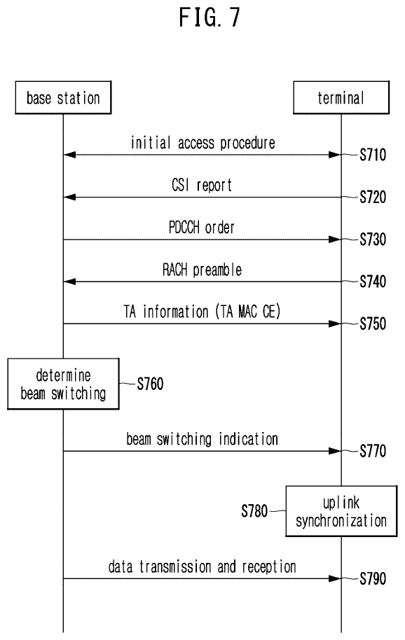

FIG. 7 is a sequence chart illustrating an exemplary embodiment of an uplink synchronization method according to beam switching operation of a terminal in a communication network.

Referring to FIGS. 6 and 7, the communication network may include at least one RIS 630. The terminal 620 may perform the initial access procedure with the base station 610 through one of the plurality of SSB beams SSB #1 and SSB #2 transmitted through beamforming from the base station 610 (S710). The initial access procedure may be a process of acquiring uplink synchronization between the terminal 620 and the base station 610.

For example, the terminal 620 may receive the second SSB beam SSB #2 among the plurality of SSB beams SSB #1 and SSB #2 transmitted from the base station 610. The terminal 620 may acquire downlink synchronization based on the second SSB beam SSB #2. The base station 610 may transmit a PDCCH order to the terminal 620 through the second SSB beam SSB #2. The base station 610 may transmit the PDCCH order to the terminal 620 using an RRC message or a DCI format. The PDCCH order may include a dedicated RACH preamble index for an initial access procedure between the base station 610 and the terminal 620, for example, for random access. The terminal 620 may select a RACH preamble based on the PDCCH order received from the base station 610. The terminal 620 may transmit the selected RACH preamble to the base station 610. The base station 610 may receive the RACH preamble from the terminal 620 and may measure a TA value based on the RACH preamble. The base station 610 may transmit TA information (e.g. TA MAC CE) including the TA value or a TA command to the terminal 620. The terminal 620 may adjust a transmission timing of an uplink signal based on the TA information received from the base station 610 and may acquire uplink synchronization with the base station 610.

After uplink synchronization of the terminal 620 is acquired, the base station 610 may transmit a plurality of CSI-RS beams included in the second SSB beam SSB #2 to the terminal 620. The terminal 620 may measure signal quality of each of the plurality of CSI-RS beams and may transmit a CSI report of measurement results to the base station 610 (S720). The terminal 620 may transmit the CSI report to the base station 610 every preconfigured period.

The base station 610 may compare signal qualities of the plurality of CSI-RS beams based on the CSI report received from the terminal 620. The base station 610 may transmit a PDCCH order to the terminal 620 for acquisition of information for uplink synchronization when a beam switching operation of the terminal 620 is performed based on a comparison result of the signal qualities (S730).

The beam switching operation of the terminal 620 may refer to an operation in which the terminal 620 performs beam switching from a serving beam of the base station 610 to a target beam. Here, the serving beam may refer to a beam transmitted from the base station 610 to the terminal 620 (e.g. the first CSI-RS beam CSI-RS #a). The target beam may refer to a beam transmitted from the base station 610 to the terminal 620 via at least one RIS 630 (e.g. the second CSI-RS beam CSI-RS #b).

The terminal 620 may receive some of the plurality of CSI-RS beams from the base station 610 in a serving-beam form and may receive the rest of the plurality of CSI-RS beams in a target-beam form. A CSI-RS beam that the terminal 620 receives in the target-beam form may have a larger propagation delay time compared to a CSI-RS beam that the terminal 620 receives in the serving-beam form. The base station 610 may classify the plurality of CSI-RS beams into a serving-beam group and a target-beam group based on the CSI report received from the terminal 620. The base station 610 may determine one beam having relatively good signal quality among at least one CSI-RS beam included in the serving-beam group as the serving beam. The base station 610 may determine one beam having relatively good signal quality among at least one CSI-RS beam included in the target-beam group as the target beam. The base station 610 may transmit, to the terminal 620, the PDCCH order including information of the target beam through the serving beam.

As shown in Table 1 below, the PDCCH order may include at least one of dedicated preamble information, physical random access channel (PRACH) occasion configuration information for a transmission resource of a preamble, for example, a time or frequency position, a CSI-RS index of the target beam, or a transmission configuration indication (TCI) state identifier (ID) that indicates a reference signal associated with the CSI-RS index.

TABLE 1

```
DCI 1_0: PDCCH Order
{
  Random Access Preamble Index
  UL/SUL Indicator
  SS/PBCH Index (SSB Index)
  PRACH MASK Index
  CSI-RS Index or TCI State ID
  ...
}
```

The terminal 620 may select a dedicated RACH preamble based on the PDCCH order received from the base station 610. The terminal 620 may transmit the dedicated RACH preamble to the base station 610 toward the target beam, in other words, toward the second CSI-RS beam CSI-RS #b, based on the CSI-RS index or the TCI State ID of the PDCCH order (S740).

The base station 610 may measure a TA value for the target beam based on the dedicated RACH preamble received from the terminal 620. The base station 610 may transmit, to the terminal 620, TA information including the measured TA value of the target beam, for example, a TA MAC CE, as a random access response (RAR). The base station 610 may transmit the TA information of the target beam to the terminal 620 through the serving beam. The terminal 620 may store the TA information of the target beam received from the base station 610 (S750).

As shown in Table 2 below, the TA MAC CE may include at least one of an SSB beam index for the target beam, a CSI-RS index for the target beam, a TCI state ID for the target beam, or a TA value for the target beam.

TABLE 2

```
TA MAC CE
{
  SSB Index
  CSI-RS Index or TCI State ID
  Timing Advance
  ...
}
```

The terminal 620 may perform data transmission and reception with the base station 610 using the serving beam received from the base station 610, for example, the first CSI-RS beam CSI-RS #a. Since the terminal 620 directly receives the serving beam from the base station 610, the terminal 620 may perform data transmission and reception with the base station 610 through the serving beam based on the uplink synchronized through the aforementioned initial access procedure.

The terminal 620 may move to a shadow area formed in the cell area while performing data transmission and reception with the base station 610. The base station 610 may determine movement of the terminal 620 to the shadow area and may determine a beam switching operation of the terminal 620 based on a determination result (S760).

For example, the base station 610 may compare signal quality of the serving beam and the target beam based on the CSI report received from the terminal 620. The base station 610 may determine the beam switching operation according to the movement of the terminal 620 to the shadow area when the target beam has relatively good signal quality compared to the serving beam.

The base station 610 may instruct the terminal 620 to perform the beam switching operation through the serving beam (S770). The base station 610 may transmit, to the terminal 620, beam switching indication information including information on a switching beam, for example, the target beam. The base station 610 may transmit the beam switching indication information to the terminal 620 using a DCI format.

The terminal 620 may perform the beam switching operation from the serving beam to the target beam based on the beam switching indication information received from the base station 610. The terminal 620 may acquire uplink synchronization for the target beam based on the beam switching operation (S780).

For example, the terminal 620 may determine whether stored TA information corresponds to the switching beam included in the beam switching indication information, in other words, to the target beam. When the terminal 620 determines that the TA information is TA information of the target beam, the terminal 620 may perform the beam switching operation from the serving beam to the target beam.

The terminal 620 may acquire uplink synchronization for the target beam based on the TA information. For example, the terminal 620 may be in a state where uplink synchronization for the serving beam is acquired through the initial access procedure. The terminal 620 may perform the beam switching operation from the serving beam to the target beam, and may adjust a transmission timing of an uplink synchronized for the serving beam based on the TA value of the stored TA information. The terminal 620 may acquire uplink synchronization for the target beam based on the adjusted uplink transmission timing. The terminal 620 may perform data transmission and reception with the base station 610 using the target beam, in other words, the second CSI-RS beam CSI-RS #b, based on the acquired uplink synchronization (S790). As described above, the second CSI-RS beam CSI-RS #b may be a beam reflected via the RIS 630 from the base station 610 and transmitted to the terminal 620. Accordingly, the terminal 620 may transmit uplink data to the base station 610 via the RIS 630 using the second CSI-RS beam CSI-RS #b.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving, through a serving beam, a physical downlink control channel (PDCCH) order including information on a target beam from a base station;
transmitting, based on the PDCCH order, a random access channel (RACH) preamble to the base station through the target beam;
receiving, through the serving beam, timing advance (TA) information for the target beam from the base station, the TA information being determined based on the RACH preamble;
receiving, through the serving beam, beam switching indication information from the base station;
performing a beam switching operation from the serving beam to the target beam based on the beam switching indication information, using the TA information; and
acquiring uplink synchronization for the target beam based on the TA information.

2. The method of claim 1, wherein the serving beam is a beam directly received from the base station, and the target beam is a beam received via at least one reconfigurable intelligent surface (RIS) associated with the base station.

3. The method of claim 1, wherein the performing of the beam switching operation comprises:
determining whether the TA information corresponds to a switching beam included in the beam switching indication information; and
performing the beam switching operation from the serving beam to the target beam based on determining that the TA information corresponds to the switching beam.

4. The method of claim 1, wherein the performing of the uplink synchronization comprises: adjusting an uplink transmission timing for the target beam based on a TA value of the target beam included in the TA information.

5. The method of claim 1, further comprising:
receiving a plurality of channel state information (CSI)-reference signals (RSs) from the base station;
measuring signal quality of each of the plurality of CSI-RSs; and
transmitting signal quality measurement results to the base station,
wherein the information on the target beam, which is included in the PDCCH order, is determined based on the signal quality measurement results.

6. The method of claim 1, further comprising:
receiving a plurality of CSI-RSs from the base station;
measuring signal quality of each of the plurality of CSI-RSs; and
transmitting signal quality measurement results to the base station,
wherein the beam switching indication information is received from the base station based on the signal quality measurement results.

7. A method of a base station, comprising:
transmitting, through a serving beam, a physical downlink control channel (PDCCH) order including information on a target beam for a beam switching operation of a terminal to the terminal;
receiving, through the target beam, a random access channel (RACH) preamble based on the PDCCH order from the terminal;
measuring a timing advance (TA) value for the target beam based on the RACH preamble;
transmitting TA information including the TA value to the terminal through the serving beam; and
transmitting, through the serving beam, beam switching indication information for switching from the serving beam to the target beam to the terminal, based on determination of whether the beam switching operation of the terminal is to be performed.

8. The method of claim 7, wherein the transmitting of the PDCCH order to the terminal through the serving beam comprises:
transmitting a plurality of channel state information (CSI)-reference signals (RSs) to the terminal;
receiving, from the terminal, signal quality measurement results for the plurality of CSI-RSs;
determining the serving beam and the target beam among the plurality of CSI-RSs based on the signal quality measurement results; and
transmitting, through the serving beam, the PDCCH order including information on the target beam to the terminal.

9. The method of claim 7, wherein the PDCCH order includes at least one of: information on a dedicated preamble, or a CSI-RS index or a transmission configuration indicator (TCI) state identifier (ID) of the target beam.

10. The method of claim 7, wherein the TA information includes at least one of: the TA value of the target beam, an SSB beam index for the target beam, or a CSI-RS index or a TCI state ID of the target beam.

11. The method of claim 7, wherein the transmitting of the beam switching indication information comprises:
transmitting a plurality of CSI-RSs to the terminal;
receiving, from the terminal, signal quality measurement results for the plurality of CSI-RSs;
determining that the terminal is to perform the beam switching operation when a signal quality of the target beam is relatively better than a signal quality of the serving beam; and
transmitting, through the serving beam, the beam switching indication information to the terminal.

12. The method of claim 7, wherein the serving beam is a beam directly transmitted from the base station to the terminal, and the target beam is a beam transmitted to the terminal via at least one reconfigurable intelligent surface (RIS) associated with the base station.

13. A terminal comprising at least one processor, wherein the at least one processor causes the terminal to perform:
receiving, through a serving beam, a physical downlink control channel (PDCCH) order including information on a target beam from a base station;
transmitting, based on the PDCCH order, a random access channel (RACH) preamble to the base station through the target beam;
receiving, through the serving beam, timing advance (TA) information for the target beam from the base station, the TA information being determined based on the RACH preamble;
receiving, through the serving beam, beam switching indication information from the base station;
performing a beam switching operation from the serving beam to the target beam based on the beam switching indication information, using the TA information; and
acquiring uplink synchronization for the target beam based on the TA information.

14. The terminal of claim 13, wherein the serving beam is a beam directly received from the base station, and the target beam is a beam received via at least one reconfigurable intelligent surface (RIS) associated with the base station.

15. The terminal of claim 13, wherein in the performing of the beam switching operation, the at least one processor causes the terminal to perform:
determining whether the TA information corresponds to a switching beam included in the beam switching indication information; and
performing the beam switching operation from the serving beam to the target beam based on determining that the TA information corresponds to the switching beam.

16. The terminal of claim 13, wherein in the performing of the uplink synchronization, the at least one processor further causes the terminal to perform: adjusting an uplink transmission timing for the target beam based on a TA value of the target beam included in the TA information.

17. The terminal of claim 13, wherein the at least one processor further causes the terminal to perform:
receiving a plurality of channel state information (CSI)-reference signals (RSs) from the base station;
measuring signal quality of each of the plurality of CSI-RSs; and
transmitting signal quality measurement results to the base station,
wherein the information on the target beam, which is included in the PDCCH order, is determined based on the signal quality measurement results.

18. The terminal of claim 13, wherein the at least one processor further causes the terminal to perform:
receiving a plurality of CSI-RSs from the base station;
measuring signal quality of each of the plurality of CSI-RSs; and
transmitting signal quality measurement results to the base station,
wherein the beam switching indication information is received from the base station based on the signal quality measurement results.
